(19) United States
(12) Patent Application Publication
(10) Pub. No.: US 2009/0145693 A1
(43) Pub. Date: Jun. 11, 2009

(54) Ladder support bracket

(76) Inventors: Daniel Arseneault, St-Clalixte (CA); Daniel Perreault, Bois-Des-Fillion (CA)

Correspondence Address: Franz BONSANG;c/o EQUINOX PROTECTION, 410 - 1500, Du College, St-Laurent, QC, H4L 5G6, CA

(21) Appl. No.: 12/149,890

(22) Filed: May 9, 2008

(30) Foreign Application Priority Data
Dec. 10, 2007 (CA) 2,611,826

(51) Int. Cl. E06C 7/06

(52) U.S. Cl. 182/206

(57) ABSTRACT

A ladder support bracket comprises a first clamp for clamping to an immovable structure connected to a second clamp for clamping to the ladder stile, the first clamp having a fixed and moveable jaw moving on a hinge shaft, and the second clamp comprising a clamping pad mounted on the hinge shaft distally from the first clamp for frictional engagement with the ladder stile upon rotation of the pad.

### FIELD OF THE INVENTION

The present invention relates to a ladder support bracket for providing a safe mounting arrangement for a ground-engaging ladder when propped up against a building.

### BACKGROUND OF THE INVENTION

It is a matter of regrettable fact that the number of accidents associated with the use of ladders is legion resulting in serious and in some instances fatal injuries. In most if not all instances, the reason for such accidents is inadequate anchoring of the ladder when in position angled against a wall or similar structure.

Many and varied arrangements have been proposed for stabilizing the ladder in its use position. For example, legs attached to the stiles of the ladder have been suggested for additional contact with the ground to give more stability and struts for contact with the supporting wall have also been used.

A more specific type of ladder support finds form in a bracket attachable at the upper end of the ladder with a clamp for positive engagement with for example a gutter of the building in question. In use the ladder is anchored at its top end to the gutter, thus assisting in the prevention of inadvertent slippage away from the intended orientation of the ladder against the wall of the building. One such bracket is described in U.S. Pat. No. 3,603,431 to Nameche et al. It will be seen from a consideration of this earlier invention that a complicated coil spring mechanism is employed for the actuation of the bracket into a gutter and roof-engaging mode. Whilst this prior patent does show a ladder support bracket intended for clamping to the ladder stiles at each side, most prior art disclosures are concerned with brackets that are clamped to a rung or rungs of the ladder. Such brackets are not regarded as being particularly efficacious in fulfilling the intended role.

Accordingly, there is a need for an improved ladder support bracket.

### SUMMARY OF THE INVENTION

It is therefore a general object of the present invention to provide an improved ladder support bracket.

An advantage of the present invention is to provide such a ladder support bracket which facilitates attachment to both the ladder and to an immovable structure against which the ladder is to be placed in a leaning orientation. Such immovable structure may include, but are not limited to, rain gutter, elevated floor surface, scaffoldings, roof edge, forming structure, metallic structure (L-,H-, I-beams), etc.

A further advantage of the invention is to provide a ladder support bracket which allows some relative movement of the ladder with respect to the immovable structure without compromising safe use of the ladder. To that effect, when frictionally clamped between two brackets (one on either side), any slight movement imposed to the ladder (such as oscillations of a user climbing up or down) will not tear apart or wear out the immovable structure that might not always be as solid as desired, or be more ‘fragile’ such as rain gutters. A still further advantage of the present invention is to provide a ladder support bracket comprising simple and yet effective clamps which are easy to position and actuate.

Another advantage of the present invention is to provide a ladder support bracket that can be installed/uninstalled using only one hand to allow the operator to keep his/her second hand secured to the ladder.

Yet another advantage of the present invention is to provide a ladder support bracket that can be secured to the ladder when unused to prevent lost thereof.

According to the present invention, there is provided a ladder support bracket comprising:
a first clamp adapted for affixture to an immovable structure;
the first clamp comprising a mounting plate forming a fixed jaw, a movable jaw hingedly connected through the agency of a shaft to the mounting plate, and a fastening knob actuable in use to close the movable jaw towards the fixed jaw;
a second clamp adapted for affixture to a stile of a ladder;
the axes of the first and second clamps being generally parallel one to the other;
the second clamp comprising a clamping pad carried on said shaft at a distal end thereof remote from the first clamp, a control knob mounted on and rigid with said shaft and adapted in use to turn the pad into frictional engagement with the stile; and
the second clamp being independently movable with respect to the first clamp.

Typically, the axes of the first and second clamps are generally collinear.

The mounting plate is conveniently of inverted U-shape with one side of the U-shape constituting the fixed jaw, which might be provided with fixing holes, for securing the first clamp to an immovable structure. The fixed jaw may be recessed to accommodate for example the gutter mounts on the immovable structure and may also be provided with a register for contacting the said structure. The other side of the U-shaped plate is provided with a hinge mount for the movable jaw, the shaft extending through the hinge mount and through a complementary hinge mount on the movable jaw, which is mounted within the U-shaped mounting plate adjacent said other side.

The movable jaw may advantageously be resiliently biased away from the fixed jaw into an open position. The other side of the U-shaped mounting plate is provided with the fastening knob which may be a simple turn screw extending through the side into contact with the movable jaw, such that in use appropriate turning of the knob effects movement of the movable jaw into clamping engagement with for example a gutter on the immovable structure.

The second clamp may be spaced from the first clamp by means of a cylindrical sleeve fixed over the shaft intermediate the two clamps with the control knob to axially fix the control knob relative to the first clamp. The clamping pad may be shaped to accord with the stile profile whereby frictional engagement is optimized and is preferably coated or provided with a high-friction surfacing material.

The second clamp may further comprise a strap arrangement for fitting over the stile, the arrangement comprising an outer plate provided with a saddle for accommodating a shaft section adjacent the control knob, with the shaft section being axially longer than a thickness of a wall of the saddle to allow for axial adjustment of the strap arrangement relative to the clamping pad, and further comprising a pair of jaws for embracing the width of the stile and its depth, the jaws being adjustable to cater for varying depths of stile. The adjustment may be provided by a simple serration engagement with finger control. Either one or each of the jaws may be provided with a resiliently biased pin for contacting an edge of the stile to prevent inadvertent sliding of the strap arrangement along the stile and to accommodate any minor variation in the width of the stile along its length.

A safety connection may be provided intermediate the strap arrangement and the first clamp and may be of a flexible type, for example a cable or the like. The first clamp when not in use is conveniently capable of being parked on the stile.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is an exploded perspective side view of a ladder support bracket in accordance with a first embodiment of the present invention; and

FIG. 1a is a perspective side view similar to that of FIG. 1 with the exploded parts married together;

FIG. 2 is an exploded view of a number of parts of the bracket;

FIG. 3 is a perspective front view of a detail of a part of the bracket;

FIG. 3a is a perspective rear view of the detail of FIG. 3;

FIG. 4 is an exploded perspective front view of the detail of FIG. 3;

FIG. 5 is a plan view of the bracket;

FIG. 6 is an end view of the bracket;

FIG. 7 is a front elevation view of the bracket;

FIG. 8 is a perspective side view of two brackets of the embodiment of FIG. 1 attached to a rain gutter and a ladder; and

FIG. 9 is an enlarged partially broken section view taken along line 9-9 of FIG. 8.

### DETAILED DESCRIPTION OF THE PREFERRED EMBODIMENTS

With reference to the annexed drawings the preferred embodiments of the present invention will be herein described for indicative purpose and by no means as of limitation.

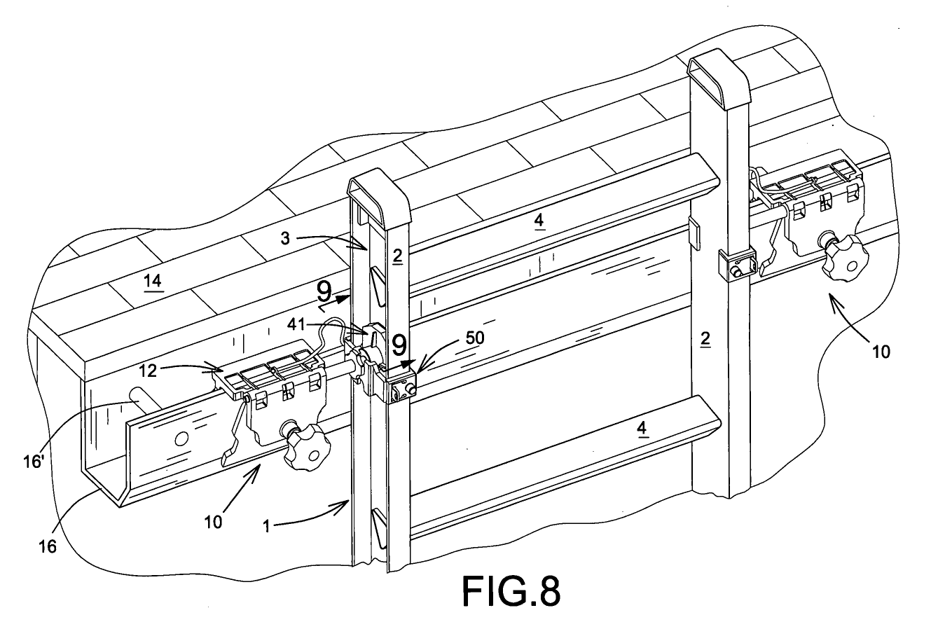

Referring to the drawings there is shown in FIG. 8 a ladder at 1 having two longitudinally extending stiles 2 of U-shaped cross section with lateral rungs 4 fixed in spaced relation along the length of the ladder 1 between the stiles 2, the ends of the rungs 4 protruding into the U-shaped space 3 of the stiles.

Typically on each side of the ladder 1, a ladder support bracket is shown generally at 10 and comprises a first clamp 12 for attachment to an immovable structure such as a wall 14 and the like and to for example roof furniture in the form of guttering shown at 16 in FIG. 8 and in ghosted outline in FIG. 6.

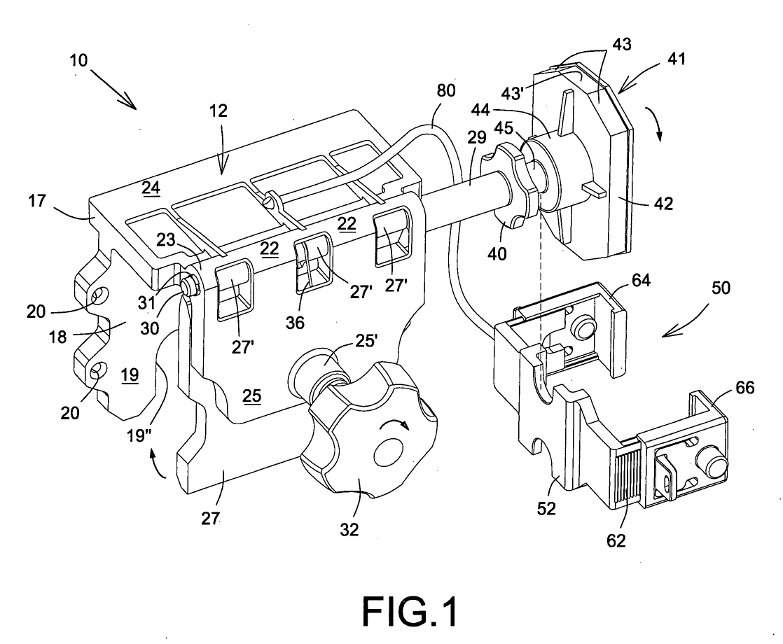

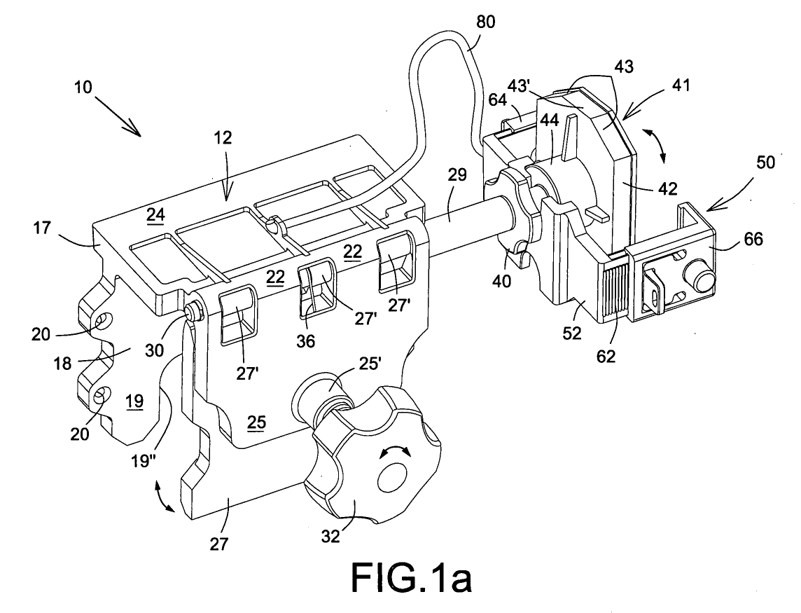

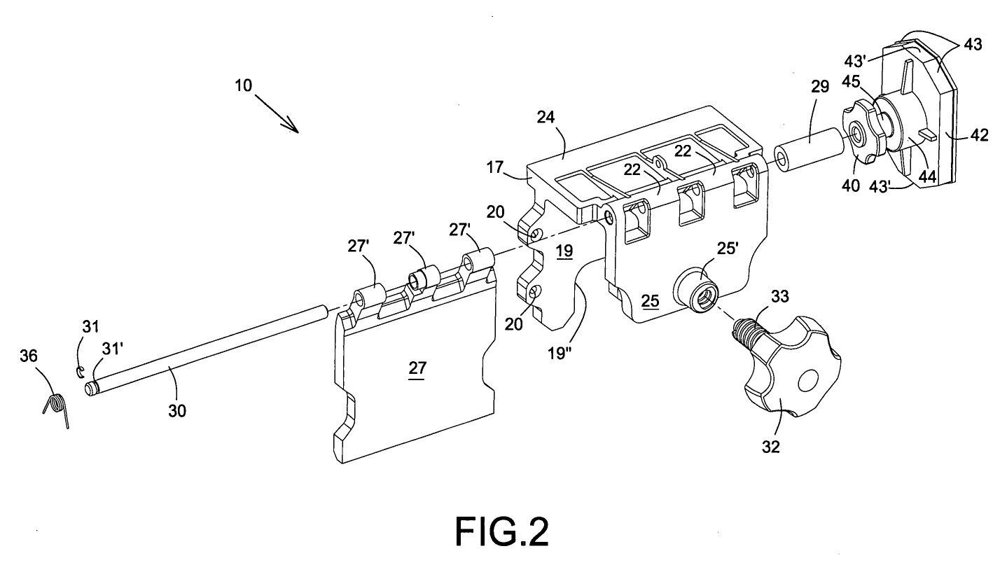

As shown in FIGS. 1 and 1a, the clamp 12 comprises a U-shaped mounting plate 18 having one wall 19 provided with fixing holes 20 for bolts, screws or the like (not shown), to secure the clamp 12 to the wall 14 or similar structure, in clamping position the plate 18 locating over and embracing the guttering 16. A register 17 is provided along the tope edge of the wall 19, when the clamp 12 is used in other positions. Hinge joints 22 are provided along the edge 23 of the U-shaped mounting plate 18 adjacent the base 24 (of the U-shape) and the outer side wall 25 of the plate 18.

The wall 19 constitutes one jaw 19′ of the clamp 12 and another moveable jaw 27 thereof is hinged to the joints 22 through complementary joints 27′ and a shaft 30 extending through the aligned joints. The shaft 30 is provided with a circlip 31 in a groove 31′ on the end of the shaft to abut the end hinge joint 22 on the plate 18. The outer side wall 25 of the plate 18 has an internally-threaded boss 25′ mounted thereon with the threading extending through the wall. A fastening knob 32 is provided with an externally-threaded spigot 33 which screws into the boss 25′ to extend through the wall 25 to contact the movable jaw 27 to move the same into or out of a clamping position in relation to the fixed jaw 19′. The jaw 27 is spring-loaded as at 36 whereby the jaw 27 is held out of the clamping position thereby to facilitate location over the guttering 16. Although not illustrated, the surfaces of the fixed and movable jaws 19′, 27 facing each other could typically be covered with a friction coating or layer to prevent accidental sliding. The guttering 16 might have wall rod brackets 16′ (as shown in FIG. 8) and the wall 19 is suitably provided with recesses 19″ to accommodate them without compromising the clamping action of the ladder bracket when in situ.

The shaft 30 extends beyond the mounting plate 18 and is provided with a spacing sleeve 29 contiguous with a control knob 40, also fixed on the shaft 30, to maintain the control knob 40 spaced apart from the first bracket 12, as shown. The control knob 40, rigid with the shaft 30, carries a second clamp 41 in the form of a clamping pad 42 typically provided with a high-friction coating or layer, for example rubber or the like, for engagement within the space 3 of the stile 2. To this end the pad 42 is typically of generally rectangular form with suitable beveling as at 43 to provide pressure surfaces, such as longitudinal end surfaces 43′, to contact the sides of the space 3 of the stile, the pad having a central boss 44. The longer side of the rectangular form having substantially the inner width dimension of the space 3.

The first 12 and second 41 clamps, with the respective fastening 32 and control 40 knobs, generally have orthogonal axes relative to one another. Accordingly, the second clamp 41 is independently movable with respect to the first clamp 12. Furthermore, the hinge axis of the wall 19 of the first clamp 12 and the axis of the second clamp 41 are generally parallel, and preferably collinear (axis of shaft 30), to one another.

In use, the ladder support bracket 10 is deployed by typically clamping the first clamp over the guttering 16. In this respect, the mounting plate 18 is offered over the guttering and emplaced as rigidly as possible; alternatively, holding bolts or screws are used in conjunction with the holes 20 to secure the wall of the plate 18 to the immovable structure 14. The fastening knob 32 is then turned clockwise to screw the spigot 33 through the boss 25′ into contact with the movable jaw 27 to pivot the jaw into contact with the guttering 16 to effect a clamping action thereon to secure the bracket 10 to thereto.

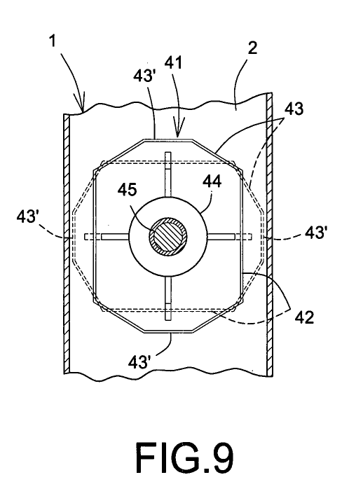

The control knob 40 is then turned and in so doing the second clamp, namely the clamping pad 42, via its pressure surfaces or edges, preferably surfaces 43′, is brought into frictional engagement with the space 3 of the stile 2, as shown in FIG. 9. Accordingly, the bracket 10 is duly secured to the wall 14 and to the ladder 1. It will be appreciated that a degree of limited movement as between the first and second clamps is possible by virtue of the hinging around the shaft, such movement being permissible to accommodate any minor variations in ground profile.

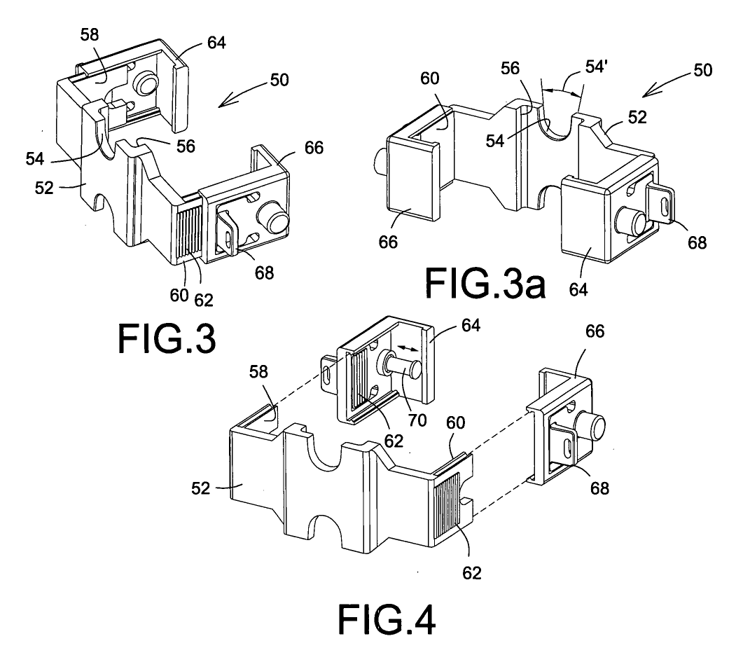

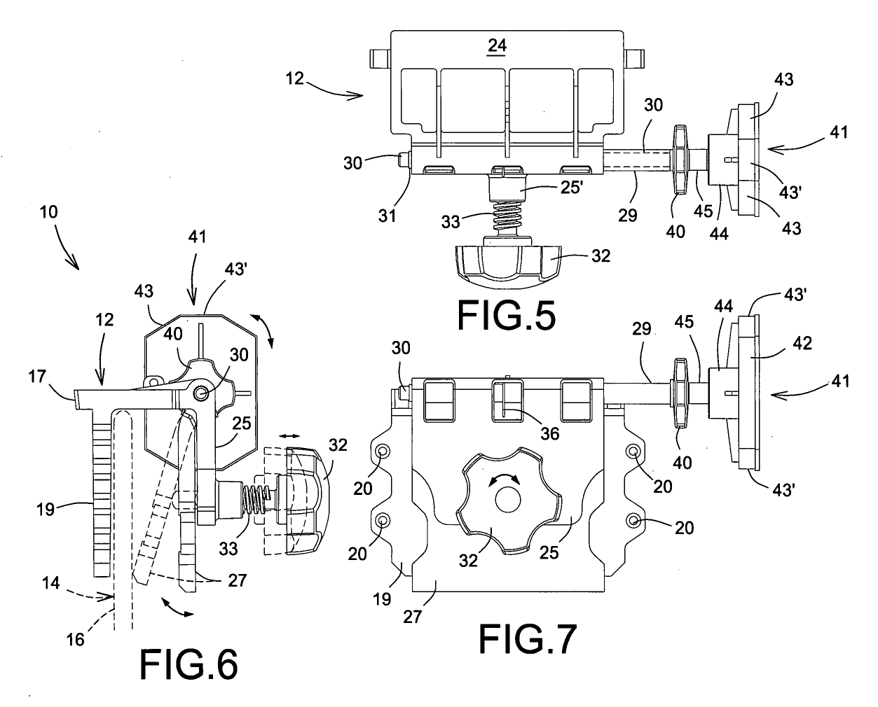

In an improved embodiment illustrated in FIGS. 3, 3a and 4, a strap arrangement 50 is provided for the ladder stile 2 in addition to the first and second clamps. The strap arrangement 50 complements the second clamp 41 and comprises an outer plate 52 provided with at least one set, preferably two opposite sets, of saddles 54, 56 for accommodating a shaft section 45 and the central boss 44 of the clamping pad 42 respectively. The saddle 54 is typically outwardly tapered to a slight extent, as shown by arrow 54′ in FIG. 3a, to center the sleeve 45 and the pad 42, whilst the saddle 56 provides a loose fit for the boss 44. Furthermore, shaft section 45 typically has an axial length generally slightly larger than the thickness of the wall of corresponding saddle 54 to provide for axial adjustment of the position of the pad 42 relative to the stile 2, to account for the ends of the rungs 4 protruding into the U-shaped space 3 of the stile.

The outer plate 52 of the arrangement 50 has side pieces 58 and 60 for embracing the stile 2 and each side piece is provided with serrations 62 which are engaged by resiliently mounted meshing serrations 62′ carried by jaws 64, 66. A finger plate 68 is provided for each meshing serrations 62′ to release same for giving fast acting movement to slidably adjust the jaws 64, 66 lengthwise of the respective side pieces 58, 60 to vary the depth of the strap arrangement 50 for accommodating any dimensional thickness variation in the stile.

The jaw 64 is typically provided with a resiliently-loaded pin 70 that is inwardly biased with only a small pressure to prevent the sliding of the strap arrangement 50 along the stile and to account for any small dimensional variations in the width of the ladder stile 2. The pressure exerted by the pin 70 is insufficient to prevent a forced displacement of the arrangement 50. Although not required, a similar resiliently-loaded pin could be mounted on the second jaw 66.

In use, use of the second embodiment merely requires location of the strap arrangement 50 on the stile 2 and interengagement of the shaft section 45 of the shaft 30 and the boss 44 in their respective saddles 54, 56 to enable the first and second clamps to operate as hereinbefore described. The second set of saddles 54, 56, allows for the strap arrangement 50 to be located either below or above the second clamp 41 along the stile 2 depending of the specific installation of the bracket 10.

The strap arrangement 50 is typically connected to the first clamp 12 by means of a flexible safety line 80 as a safety connection. Instead of relying on the safety line 80 to carry the first clamp 12 along with the ladder 1 upon small displacement of the latter (such as when cleaning the gutters 16), the first clamp 12 could be simply supported by the strap arrangement 50 with the second clamp 41 engaging saddles 54, 56.

Ideally, a strap arrangement would be located on each stile and a second ladder support bracket would be provided for additional stability, as shown in FIG. 8.

In the event that the ladder stile does not have the cross section illustrated with space 3, the second clamp would be provided with side limbs to embrace the margins of the stile to ensure appropriate capture and thus effective clamping.

It will be appreciated that the installation of the ladder support bracket does require an operative, typically using only one hand, to secure the clamps in position when the ladder is in situ.

While a specific embodiment of the ladder support bracket of the present invention has been described, those skilled in the art will recognize many alterations that could be made within the spirit of the invention. The description provided herein is provided only for purposes of illustration, and not for purposes of limitation.

We claim:

1. A ladder support bracket comprising:
a first clamp adapted for affixture to an immovable structure;
the first clamp comprising a mounting plate forming a fixed jaw, a movable jaw hingedly connected through the agency of a shaft to the mounting plate, and a fastening knob actuable in use to close the movable jaw towards the fixed jaw;
a second clamp adapted for affixture to a stile of a ladder;
the axes of the first and second clamps being generally parallel one to the other;
the second clamp comprising a clamping pad carried on said shaft at a distal end thereof remote from the first clamp, a control knob mounted on and rigid with said shaft and adapted in use to turn the pad into frictional engagement with the stile; and
the second clamp being independently movable with respect to the first clamp.

2. A ladder support bracket as claimed in claim 1 wherein the mounting plate is of U-shape with one side of the U-shape constituting the fixed jaw.

3. A ladder support bracket as claimed in claim 2 wherein the fixed jaw is provided with fixing holes adapted for securing the first clamp to an immovable structure.

4. A ladder support bracket as claimed in claim 1 wherein the fixed jaw is recessed for providing in use clearance for any obstructions on the immovable structure in the vicinity of the first clamp.

5. A ladder support bracket as claimed in claim 1 wherein the fixed jaw is provided with a register for contacting in use the immovable structure.

6. A ladder support bracket as claimed in claim 2 wherein the U-shaped mounting plate has another side provided with a hinge mount for the moveable jaw, the shaft extending through the hinge mount and a complementary hinge mount on the moveable jaw, the moveable jaw being mounted within the U-shaped mounting plate adjacent said other side.

7. A ladder support bracket as claimed in claim 6 wherein the moveable jaw is resiliently biased away from the fixed jaw into an open position.

8. A ladder support bracket as claimed in claim 7 wherein the other side of the U-shaped mounting plate is provided with the fastening knob.

9. A ladder support bracket as claimed in claim 8 wherein the fastening knob is a turn-screw extending through the other side of the U-shaped mounting plate into contact with the moveable jaw such that in use appropriate turning of the knob effects movement of the moveable jaw into a clamping mode.

10. A ladder support bracket as claimed in claim 1 wherein the second clamp is spaced from the first clamp by means of a cylindrical spacing sleeve fixed over the shaft intermediate the two clamps, thereby axially fixing the control knob relative to the first clamp.

11. A ladder support bracket as claimed in claim 10 wherein the clamping pad is shaped to accord with the stile profile.

12. A ladder support bracket as claimed in claim 11 wherein the clamping pad is provided with a layer of high-friction surfacing material.

13. A ladder support bracket as claimed in claim 11 wherein the second clamp further comprises a strap arrangement adapted for fitting around the stile, the arrangement comprising an outer plate provided with a saddle adapted to accommodate a shaft section adjacent the control knob.

14. A ladder support bracket as claimed in claim 13 wherein the shaft section is axially longer than a thickness of a wall of the saddle to allow for axial adjustment of the strap arrangement relative to the clamping pad.

15. A ladder support bracket as claimed in claim 14 wherein the strap arrangement further comprises a pair of jaws adapted to embrace the width and depth of the stile.

16. A ladder support bracket as claimed in claim 15 wherein the jaws of the strap arrangement are adjustable.

17. A ladder support bracket as claimed in claim 16 wherein the adjustment of the jaws is provided by a serration engagement with finger control.

18. A ladder support bracket as claimed in claim 15 wherein at least one of the jaws is provided with a resiliently-biased pin adapted to contact an edge of the stile.

19. A ladder support bracket as claimed in claim 14 wherein a safety connection is provided intermediate the strap arrangement and the first clamp.

20. A ladder support bracket as claimed in claim 19 wherein the safety connection is flexible.

21. A ladder support bracket as claimed in claim 1 wherein the axes of the first and second clamps are generally collinear.

22. A ladder support bracket comprising:
a first clamp adapted for affixture to an immovable structure;
the first clamp comprising a mounting plate forming a fixed jaw, a movable jaw hingedly connected through the agency of a shaft to the mounting plate, and a fastening knob actuable in use to close the movable jaw towards the fixed jaw;
a second clamp adapted for affixture to a stile of a ladder;
the axes of the first and second clamps being generally parallel one to the other;
the second clamp comprising a clamping pad, the pad being carried on said shaft at a distal end thereof remote from the first clamp, a control knob mounted on and rigid with the shaft and a spacing sleeve on the shaft intermediate the two clamps, the control knob being adapted in use to turn the pad into frictional engagement with the stile; and the second clamp further comprises a strap arrangement adapted for fitting around the stile, the arrangement including an outer plate provided with a saddle adapted to accommodate the a shaft section adjacent the control knob; and
the second clamp being independently movable with respect to the first clamp.
